(19) United States
(12) Patent Application Publication
(10) Pub. No.: US 2014/0034628 A1
(43) Pub. Date: Feb. 6, 2014

(54) TEMPERATURE CONTROL MODULE FOR ELECTRIC BLANKETS

(71) Applicant: CHIEN-CHOU CHEN, TAINAN CITY (TW)

(72) Inventor: CHIEN-CHOU CHEN, TAINAN CITY (TW)

(21) Appl. No.: 13/567,186

(22) Filed: Aug. 6, 2012

(51) Int. Cl. H05B 3/00

(52) U.S. Cl. 219/212

(57) ABSTRACT

A temperature control module for electric blankets includes a heating wire located within the electric blanket, and a control unit and a switch unit are fixed to the electric blanket. The control unit and the switch unit are separated from each other. The switch unit is located on the electric blanket so that the users can easily access and operate the switch unit to control the temperature of the electric blanket.

### BACKGROUND OF THE INVENTION

1. Field of the Invention

The present invention relates to a temperature control module for electric blankets, and more particularly, to a temperature control module with multiple controlling members installed in a box for convenience of operation.

2. Description of Related Art

The conventional electric blanket generally comprises heating wires located within the blanket and the heating wires are connected with the power cable from which the electric power is transmitted. The electric power makes the heating wires generate heat. In order to control the temperature of the heating wires, a control unit is connected between the heating wires and the power cable. As shown in FIG. 6, the conventional electric blanket 6 comprises a power cable 61 and heating wires 63 which are located within the blanket 62. A control box 64 is connected between the power cable 61 and the heating wires 63. The control box 64 has knobs or switches to control the current passing through the heating wires 63 via the control of the circuit of the control box 64. FIG. 7 shows another conventional electric blanket 7 which comprises a power cable 71 and heating wires 73 which are located within the blanket 72. A control box 74 is connected between the power cable 71 and the heating wires 73. A transformer 75 is connected between the control box 74 and the power cable 71 so as to transform the alternative current into direct current to protect the circuit in the control box 74.

The control box 64/74 and the power cable 61/71 are put on the table or on the floor, when the users want to operate the control box 64/74, the have, to pull the power cable 61/71 and the control box 64/74 close to them so as to operate the knobs or switches on the control box 64/74. Besides, the power cable 61/71 and the control box 64/74 are heavy so that the operation of the conventional electric blankets 6/7 is not convenient for the users.

U.S. Pat. No. 3,422,244 discloses an electric blanket employing a silicon controlled rectifier to control the heating element of the electric blanket, and having means to select the temperature to which it is desired to heat the sleeping area associated with use of the electric blanket. Temperature sensitive means are utilized in the control circuit connected to the silicon controlled rectifier, to control conduction of the silicon controlled rectifier and thereby the heating element current, to maintain the sleeping area temperature at the desired selected temperature. The blanket comprises a particular configuration to maximize temperature control sensitivity and blanket utility. However, the control button and the wire connected with the plug are exposed from the electric blanket, so that the wire is easily pulled and damaged. Besides, the exposed wire and plug cause difficulties when the electric blanket is transported and stored. The exposed wire and plug are easily contaminated and the electric blanket is also contaminated by the wire and blanket.

U.S. Pat. No. 3,437,792 discloses an electric heating device which comprises an integrated structure having three connected layers or plies of material for use as an electric blanket and the like. The first layer comprises a decorative layer that may be used as a covet The second layer is normally positioned adjacent to the selected area to be heated. A third layer is interposed between the first and second layers and contains a heating element that is substantially coextensive with the area to be heated. The second layer is of sufficient size to that, when the heating device is used as an electric blanket, it may be tucked into the bed. The first layer is of sufficient size so that it may then be used as a decorative bed cover. An electric control circuit including an electronic switch that comprises a thyristor is used to control activation of the heating element, and comprises a temperature control means mounted in the second layer that functions to maintain the selected area at a temperature determined by temperature selection means mounted in the first layer. However, the parts and means received in the first layer of the electric blanket in the invention are heavy which makes the users feel uncomfortable.

Both of the prior inventions do not provide a visible display of the temperature so that the users have to feel and guess the temperature when using the electric blankets.

The present invention intends to provide a temperature control module for electric blankets, wherein the control members are located in the control box to form a temperature control module which is easily operated.

### SUMMARY OF THE INVENTION

The present invention relates to a temperature control module for electric blankets and comprises a heating wire located in the electric blanket and a control unit is fixed to the electric blanket and has a control box. A circuit board is located in the control box and has a first connector and a thyristor connected thereto. The thyristor is electrically connected to the first connector. The thyristor is electrically connected to the heating wire by a conductive wire. A micro processor is connected to the circuit board and electrically connected with the thyristor. The circuit board, the first connector, the thyristor and the micro processor are installed in the control box. A switch unit is separated from the control unit and secured to the electric blanket. The switch unit has a circuit hoard, buttons and a display member connected to the circuit board of the switch unit. The micro processor is electrically connected to the circuit hoard of the switch unit by a conductive wire. Both the conductive wire connected between the thyristor and the heating wire and the conductive wire connected between the micro processor and the switch unit are located in the electric blanket.

The primary object of the present invention is to provide a electric blanket wherein the switch unit is located on the electric blanket so that the users can easily access and operate the switch unit to control the temperature of the electric blanket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric blanket of the present invention;

FIG. 2 shows the control unit and the switch unit connected to the electric blanket of the present invention;

FIG. 3 shows the circuit of the electric blanket of the present invention;

FIG. 4 shows another circuit of the electric blanket of the present invention;

FIG. 5 is a perspective view to show another embodiment of the electric blanket of the present invention;

FIG. 6 shows the conventional electric blanket, and

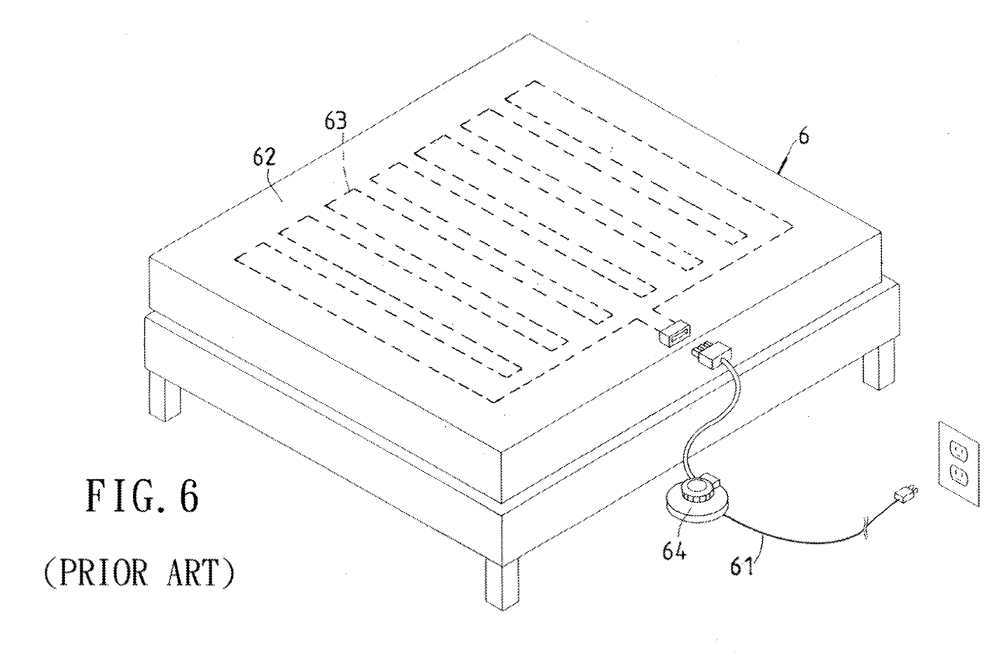

FIG. 7 shows another conventional electric blanket.

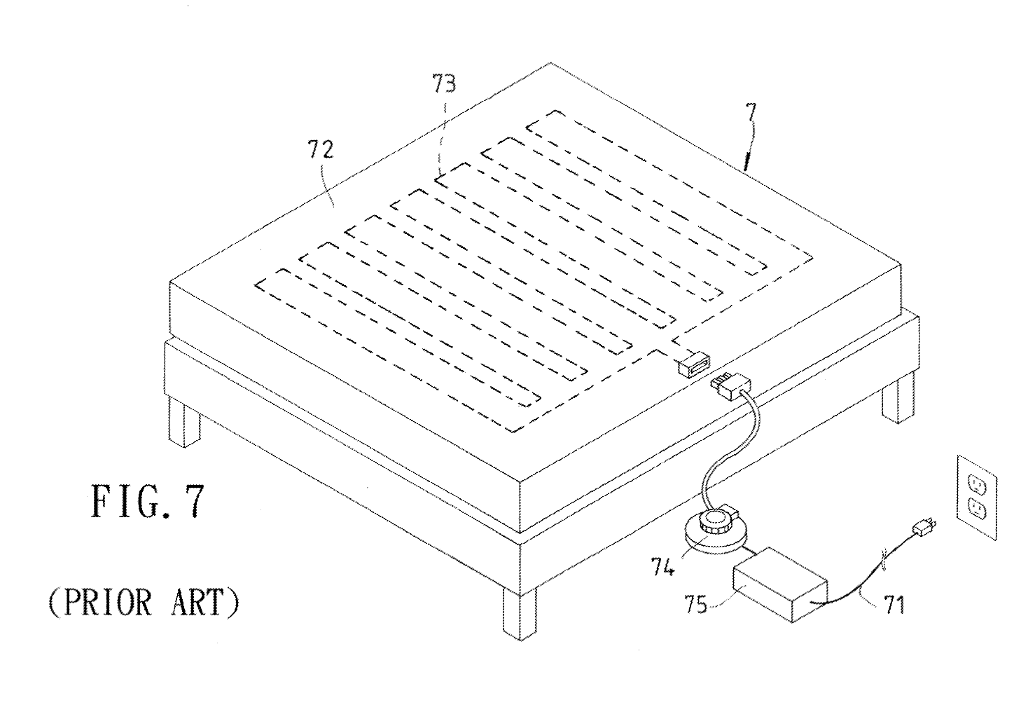

### DETAILED DESCRIPTION OF THE PREFERRED EMBODIMENT

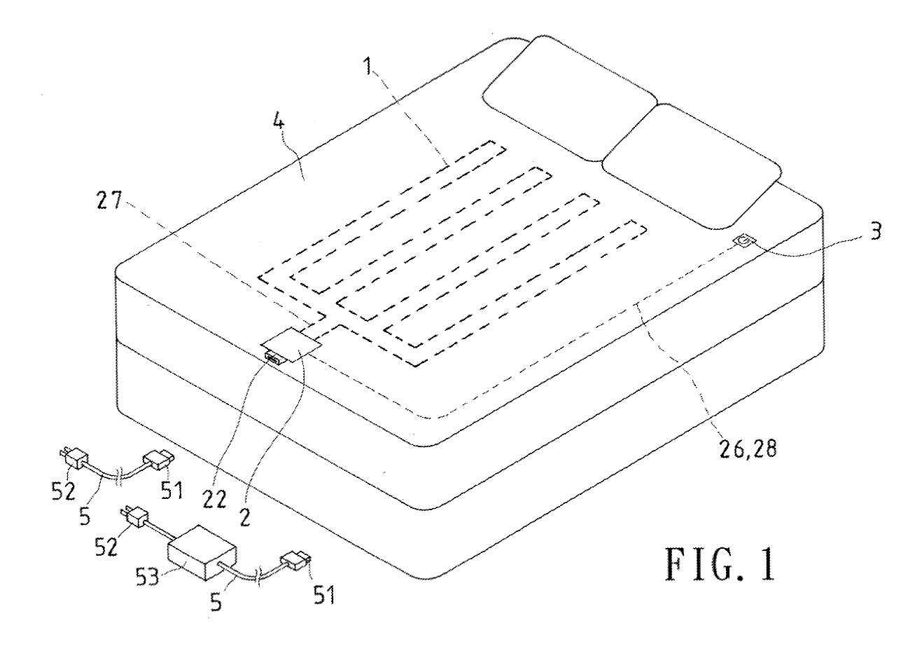

Referring to FIG. 1, the temperature control module for electric blankets of the present invention comprises a heating wire 1, a control unit 2 and a switch unit 3.

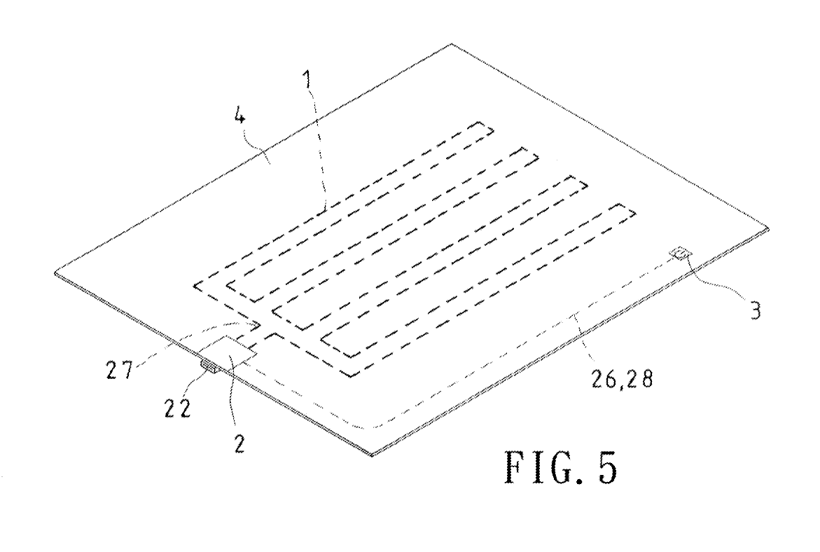

The heating wire 1 is located in the electric blanket 4 which can be a heating mattress or a heating throw as shown in FIG. 5.

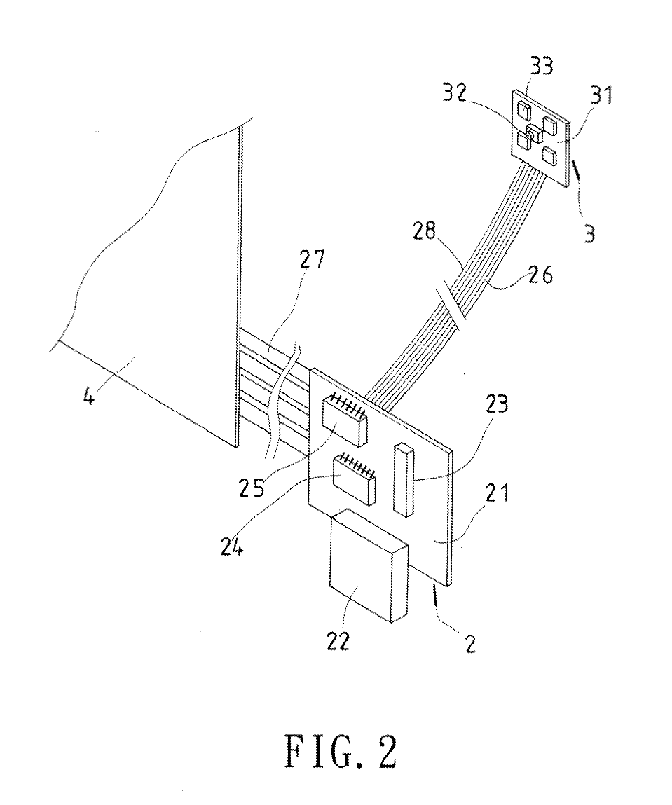

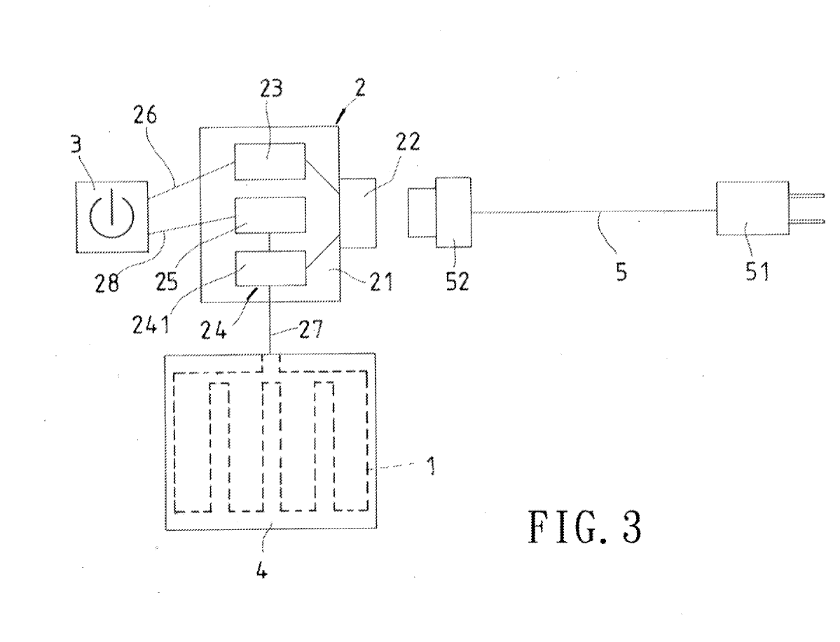

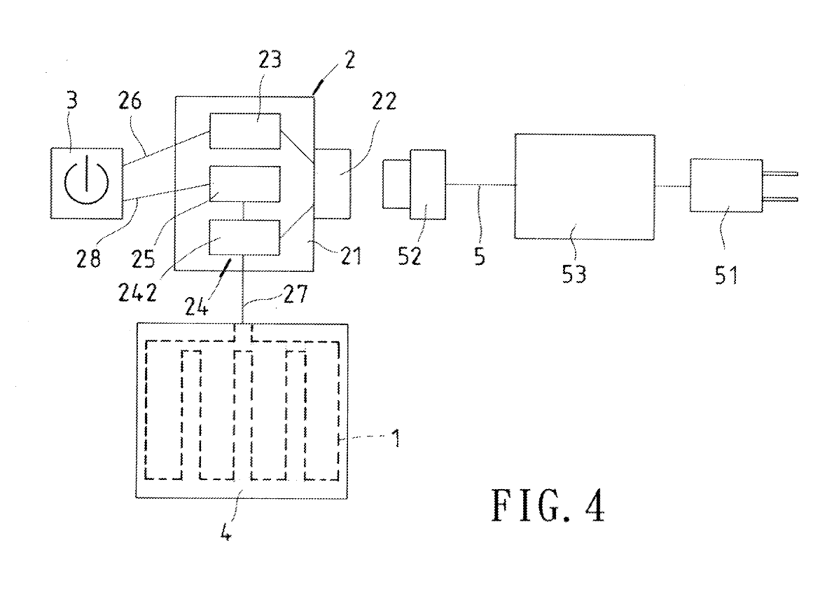

Referring to FIGS. 2 to 4, the control unit 2 is secured to the electric blanket 4 and preferably, the control unit 2 is secured to one side of the underside of the electric blanket 4. The control unit 2 has a control box 20 and a circuit hoard 21 is located to the circuit board 21 in the control box 20. The circuit board 21 has a first connector 22 and a step-down member 23 which is electrically connected to the first connector 22. The step-down member 23 is electrically connected to the circuit board 31 of the switch unit 3 by a conductive wire 26. The control unit 2 has a thyristor 24 connected to the circuit board 21 and the thyristor 24 is electrically connected to the first connector 22. The thyristor 24 is cooperated with the Silicon Controlled Rectifier (SCR) 241 as shown in FIG. 3, or with the Metal-Oxide-Semiconductor Field-Effect Transistor (MOSFET) 247 as shown in FIG. 4. The thyristor 24 is electrically connected to the heating wire 1 by a conductive wire 27. A micro processor 25 is connected to the circuit board 21 and electrically connected with the thyristor 24. The micro processor 25 is electrically connected to the circuit board 31 of the switch unit 3 via the conductive wire 28. The conductive wires 26, 28 of the switch unit 3 and the conductive wire 27 of the heating wire 1 are located in the electric blanket 4. Therefore, the circuit board 21, the first connector 22, the step-down member 23, the thyristor 24 and the micro processor 25 are installed in the control box 20 to form a module.

The control unit 2 and the switch unit 3 are separated from each other, and both are connected to the electric blanket 4, preferably, connected to the top side of the electric blanket 4. The switch unit 3 has a circuit board 31, buttons 32 and a display member 33 connected to the circuit hoard 31 thereof. The display member 33 can be a liquid, crystal screen, a digital tube or display bars which light up according to the temperature.

When the second connector 51. on the power cable 5 is connected to the first connector 22 on the electric blanket 4, and a plug 52 at the other end of the power cable 5 is electrically connected with the power source, a transformer 53 can be used between the second connector 51 and the plug 52 when needed, the heating wire 1 generates heat by operation to the switch unit 3. The user can press the button 32 for 2-3 seconds to send the signal to the micro processor 25 of the control unit 2 via the conductive wire 28 of the circuit board 31. The micro processor 25 activates the thyristor 24 to open so that current passes through the heating wire 1 via the first connector 22 and the thyristor 24. The user feels warm.

When the thyristor 24 is activated by pressing the button 32 for 2-3 seconds, the micro processor 25 sends a signal to the temperature display member 33 via the conductive wire 28 to show that the power is “ON”. When the user wants to adjust the temperature of the heating wire 1, the button 32 is pressed 1-2 seconds. The signal corresponding to that of the button 32 is pressed 1-2 seconds is sent to the micro processor 25 via the conductive wire 28 of the circuit board 31. The micro processor 25 activates the thyristor 24 to adjust the level of the current that passes through the heating wire 1 to adjust the temperature. The micro processor 25 sends a signal to the temperature display member 33 via the conductive wire 28 to show that the temperature is adjusted. Therefore, the temperature can be adjusted by the operation of the button 32 and the result of the adjustment is displayed by the temperature display member 33 of the switch unit 3.

When the user wants to stop the operation of the heating wire 1, the user presses the button 32 for a longer period of time. The longer period of pressing action to the button 132 is sent to the micro processor 25 via the conductive wire 28 and the circuit board 31, the micro processor 25 shuts off the thyristor 24 so that no current will pass through the heating wire 1. The micro processor 25 sends a signal to the temperature display member 33 via the conductive wire 28 to show that the thyristor 24 is shut off and the temperature display member 33 shows the status.

The switch unit 3 is located on the electric blanket 4 so that the users can easily access and operate the switch unit 3 to control the temperature of the electric blanket 4. Besides, the conductive wires 26, 27, 28 are located in the electric blanket 4 so that the electric blanket 4 is easily transported and stored. The temperature display member 33 displays the current temperature and this is convenient for the users.

While we have shown and described the embodiment in accordance with the present invention, it should be clear to those skilled in the art that further embodiments may be made without departing from the scope of the present invention.

What is claimed is:

1. A temperature control nodule for electric blankets, comprising:
a heating wire located in a electric blanket;
a control unit fixed to the electric blanket and having a control box, a circuit board located in the control box and having a first connector and a thyristor connected thereto, the thyristor electrically connected to the first connector, the thyristor electrically connected to the heating wire by a conductive wire, a micro processor connected to the circuit board and electrically connected with the thyristor, the circuit board, the first connector, the thyristor and the micro processor installed in the control box;
a switch unit separated from the control unit and secured to the electric blanket, the switch unit having a circuit board, buttons and a display member connected to the circuit board of the switch unit, and
the micro processor electrically connected to the circuit board of the switch unit by a conductive wire, both the conductive wire connected between the thyristor and the heating wire and the conductive wire connected between the micro processor and the switch unit being located in the electric blanket.

2. The temperature control module for electric blankets as claimed in claim 1, wherein the control unit has a step-down member connected to the circuit board of the control box, the step-down member is electrically connected to the first connector, the step-down member is electrically connected to the circuit hoard of the switch unit by a conductive wire which is located in the electric blanket.
